(19) United States
(12) Patent Application Publication
(10) Pub. No.: US 2010/0131862 A1
(43) Pub. Date: May 27, 2010

(54) METHOD OF DYNAMICALLY CREATING COMPLEX MULTIMEDIA OBJECTS

(75) Inventors: Damien Douani, Paris (FR); Corinne Moreau, Paris (FR); Pierre Bonnefoy, Luce (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/597,543

(22) PCT Filed: Apr. 18, 2008
(86) PCT No.: PCT/FR08/50707

§ 371 Date: Oct. 26, 2009

(30) Foreign Application Priority Data
Apr. 27, 2007 (FR) 0754773

(51) Int. Cl. G06F 3/048

(52) U.S. Cl. 715/753; 715/765; 715/769

(57) ABSTRACT

The invention relates to a method of creating at least one complex multimedia object intended to be reproduced in a multimedia environment. According to the invention such a method includes a step (21) of dynamically encapsulating at least one second multimedia object (12) in a first multimedia object (11) to form a complex multimedia object (110) having behavioral characteristics in said multimedia environment defined in a list (150) of behavioral characteristics associated with it obtained by transferring into a list (13) of behavioral characteristics associated with said first multimedia object (11) a set of characteristics contained in a list (14) of behavioral characteristics associated with said second multimedia object (12).

The present invention relates to the field of creating multimedia environments that can be accessed and consulted via a communications network, for example the Internet, by means of a communications terminal.

More precisely, the invention relates to the creation of complex multimedia objects intended to enrich in a personal and sophisticated manner interactive multimedia websites created by people seeking to make available and to share their content.

Such multimedia environments, with free or restricted access, many now flourishing on the Internet as blogs that constitute personalized spaces for discussion and exchange between people, are also increasingly representative of the personality and creativity of their authors.

In the opinion of the inventors, the presently-available tools for creating such multimedia environments that are accessible on line to users of fixed or mobile communications terminals, for example terminals connected to the Internet, prove to be relatively impoverished in terms of creative functionality and capacity.

At best, such tools merely offer functions for manipulating and formatting pages of text, photos or images, video clips, and sound files, in a basic manner, i.e. with no additional scope for creativity.

To attempt to remedy this failing, more sophisticated professional software solutions such as Dreamweaver, Photoshop, or Flash from Macromedia (registered trade marks) have been developed to provide tools for designing multimedia environments, in particular websites, that are rich in terms of appearance, rendition, and/or interactivity.

Such design tools are used in particular to apply numerous graphics and/or animation effects to multimedia components intended to be integrated into such on-line multimedia environments.

A first drawback of the above-mentioned design tools relates to how complicated they are to use, since they are usually reserved to professional creators or designers specializing in the design of on-line multimedia environments.

A second drawback of the above-mentioned design tools thus concerns their lack of compatibility for amateur users or at least for people relatively unfamiliar with website creation techniques and data processing tools, although such people would nevertheless like to be able to design and share with others a personal multimedia environment of the blog type that is as attractive as possible in terms of graphical richness and multimedia design.

A further drawback of these design tools, rather more intended as they are for professional use, is linked to the fact that they involve off-line design requiring finalization of the created multimedia environment before it is placed on line on a server through which users can connect to said environment by means of a communications terminal.

Thus such professional tools do not allow direct creation of multimedia environments on line, i.e. directly through an Internet browser, which rules out a simple and intuitive approach to the design of such environments and can further contribute to limiting the creativity of authors.

The present invention offers a solution that is free of the drawbacks referred to above.

The invention aims to remove the drawbacks referred to above by proposing a method enabling people to create in the simplest and most intuitive manner possible, directly, on-line, and without requiring any prior training, a multimedia environment of the blog or website type that is nevertheless rich in terms of creativity and multimedia rendition.

It is notably a question of being able, by means of the present invention, to make available to creative users a simple way of creating complex multimedia objects for creating such personalized websites.

To this end, the invention provides a method of creating at least one complex multimedia object intended to be reproduced in a multimedia environment accessible on-line by means of a communications terminal connected to a communications network, for example the Internet.

According to the invention such a method includes a step of dynamically encapsulating at least one second multimedia object in a first multimedia object to form a complex multimedia object having behavioral characteristics in said multimedia environment defined in a list of behavioral characteristics associated with it obtained by transferring into a list of behavioral characteristics associated with said first multimedia object a set of characteristics contained in a list of behavioral characteristics associated with said second multimedia object.

Such a technical approach proves particularly beneficial in that it allows direct creation of complex multimedia objects in an on-line creation environment. Such complex multimedia objects are thus created in a natural and intuitive manner by amateur authors and designers simply by encapsulating multimedia objects in other multimedia objects whose presentation and interaction possibilities are therefore significantly enriched.

In a preferred implementation of the invention, said encapsulation step is preceded by a step of verifying that said second multimedia object is of a type that belongs to a set of multimedia object types associated with said first multimedia object and for which encapsulation in said first multimedia object is authorized.

Such verification ensures that the first and second multimedia objects are compatible before proceeding to the encapsulation step. This feature has the additional advantage of guaranteeing that a complex multimedia object created by means of the method of the invention has the benefit of unity of interaction and rendition when it is reproduced on the screen of the communications terminal of a user via a communications network connected to the multimedia environment hosting said complex multimedia object.

Said dynamic encapsulation step is preferably triggered after dragging and dropping said second multimedia object onto at least one predetermined area of said first multimedia object.

Such a function proves particularly beneficial through its intuitive and dynamic side as perceived by the amateur designer, who can now create simply and dynamically complex multimedia objects intended to be reproduced in a personal on-line multimedia environment, for example a blog, by simply dragging and dropping one multimedia object onto another.

In one particular implementation of the invention, said verification step is executed when said second multimedia object is dragged over said predetermined area of said first multimedia object.

Thus when the user drags the second multimedia object over at least one predetermined area of the first multimedia object, verification of the compatibility of the two multimedia objects is activated.

Thus during said verification step said predetermined area advantageously delivers visual and/or sound information representative of the result of said verification step.

It is important to point out here that, still with the objective of encouraging creativity through the use of simple and intuitive design functions, a plurality of predetermined areas can be defined in the same multimedia object to encapsulate a plurality of multimedia objects of different types within that multimedia object. Such areas can also be intuitively modified at will through the use of functions for moving them, rotating them, resizing them, etc.

In one implementation of the method of the invention, said encapsulation step is effected by manually transferring into a list of behavioral characteristics associated with said first multimedia object a set of characteristics contained in a list of behavioral characteristics associated with said second multimedia object.

Said first multimedia object being contained in a first multimedia environment and said second multimedia object being contained in a remote second multimedia environment, said first and second multimedia environments being connected to each other by means of a communications network, said dynamic encapsulation step is advantageously a step of creating a communicating complex multimedia object intended to be reproduced in said first multimedia environment and adapted to exchange information with said second multimedia object via said communications network.

It is thus possible to create a complex multimedia object adapted to exchange information with at least one other multimedia object from another, remote multimedia environment, for example for the purposes of updating information.

The particular advantage of such a facility is that updating a multimedia object in a first multimedia environment can identically update the same (cloned) object encapsulated in a complex multimedia object in a remote second environment.

The method of the invention preferably defines a relationship of belonging and/or of ownership between said complex multimedia object and at least one user and/or at least one multimedia environment in which said complex multimedia object is reproduced.

This concept of belonging can advantageously provide a basis for implementing mechanisms for tracking and/or managing rights of use associated with the complex multimedia objects created.

In one particular implementation of the invention, in which said multimedia environment is an interactive multimedia environment accessible on line via a communications network and at least one content server connected to said network, said uniquely identified complex multimedia object is associated with at least one description and configuration file stored in at least one memory space reserved for said interactive multimedia environment in said content server and containing said list of behavioral characteristics associated with said complex multimedia object.

The description and configuration file therefore holds all the behavioral characteristics of the various complex multimedia objects created in this way, which makes them reusable and encourages their reuse.

The invention also provides a multimedia object adapted to be reproduced in a multimedia environment and produced by the above-mentioned method of creating a complex multimedia object.

The invention further provides a computer program product downloadable from a communications network and/or stored on an information medium readable by a computer and/or executable by a microprocessor.

According to the invention, such a program includes code instructions for executing in a multimedia environment a method of creating a complex multimedia object by the above-mentioned method of creating a complex multimedia object.

The invention further provides an interactive multimedia environment accessible on line from a communications terminal connected to at least one interactive multimedia content server via a communications network, said environment including at least one consultation area for consulting a plurality of multimedia objects arranged to form a multimedia scene, said consultation area optionally being shared by a plurality of users.

According to the invention such an environment includes at least one complex multimedia object as defined above.

In a preferred embodiment of the invention, said multimedia environment includes at least one dedicated space for on-line creation of at least one complex multimedia object as described above adapted to be reproduced in said consultation area, access to said dedicated creation space being restricted to certain predetermined users.

The technical advantages and features of the present invention emerge more clearly from the following description, which is given by way of non-limiting illustration and with reference to the appended drawings, in which:

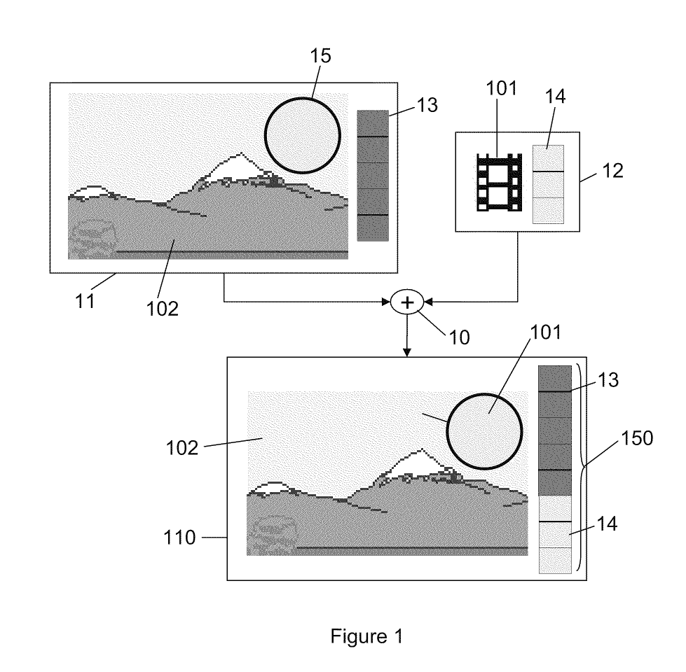

FIG. 1 is a diagram of the general principle of the method of the invention for creating a complex multimedia object; and

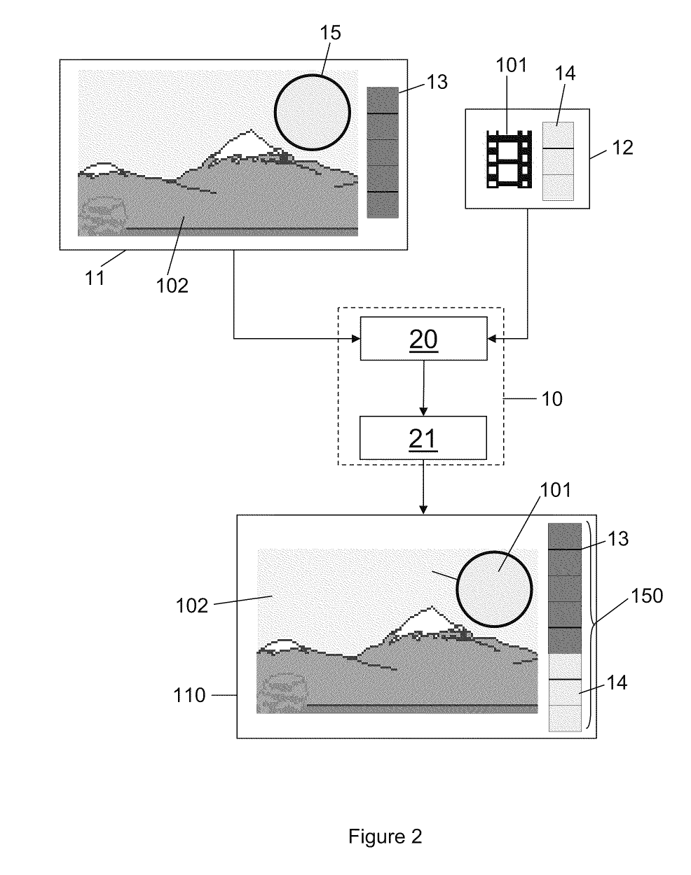

FIG. 2 is a flowchart showing the major steps of the method of the invention for creating a complex multimedia object.

The present invention proposes a solution allowing greater richness of self-expression on the Internet, for example through blogs, websites, etc.

This enhanced richness is made possible by creating complex multimedia objects by dynamic and intuitive encapsulation of multimedia objects in other multimedia objects: photos in novel frames, video or music clips in videogame players with an interactive interface, the whole composed into an audiovisual patchwork.

A complex multimedia object, called a magnet in the remainder of the present document, is a multimedia object into which one or more other multimedia objects can be integrated with the aim of forming a new one that advantageously has visual unity and interaction or behavioral unity.

This interaction and/or behavioral unity is manifested in particular in the capacity of a magnet to be able:
to be moved in a multimedia environment in which it is to be reproduced;
to be rotated;
to be resized;
to be transmitted for reproduction in a predetermined other multimedia environment;
to be saved;
to be executed (to play back a video or sound file contained in the magnet), etc.

It is very simple to create a complex multimedia object by encapsulating in a first multimedia object at least one other multimedia object either by means of a contextual menu associated with the first multimedia object and proposing a list of other multimedia objects that can be encapsulated in the first multimedia object or by means of a drag-and-drop operation in a predetermined and predefined area of the first multimedia object.

As shown in FIG. 1, in both implementations proposed above, the encapsulation 10 of at least one second multimedia object 12 in a first multimedia object 11 (an image 102 in the non-limiting and illustrative example of FIG. 1) is achieved by adding to a list 13 of reproduction and/or behavioral characteristics associated with the first multimedia object 11 at least one reproduction and/or behavioral characteristic contained in a list 14 of reproduction and/or behavioral characteristics associated with said second multimedia object 12 (a video clip 101 in the FIG. 1 non-limiting illustrative example).

In the implementation allowing encapsulation of a second multimedia object 12 in a first multimedia object 11 to produce a complex multimedia object 110, the complex multimedia object 110 defines in its code which types of multimedia object it is able to encapsulate and into which area 15 of the first multimedia object they can be integrated.

When created, a complex multimedia object contains event management means of the drag-and-drop type that are activated dynamically when the second multimedia object 12 is dragged over the predetermined graphic area 15 of the first multimedia object 11 into which it is to be encapsulated.

Thus, when the second object 12 is dragged over the area 15 of the first multimedia object 11 a compatibility check is carried out to verify that the first multimedia object 11 is adapted or authorized to encapsulate the second multimedia object 12.

When a second multimedia object 12 is dropped onto the predefined addition area 15 of the first multimedia object 11, the second object 12 is integrated into the first multimedia object 11 to produce a complex multimedia object 110 formed of said first multimedia object 11 and said second multimedia object 12.

Created dynamically and in a very simple and intuitive manner, the complex multimedia object 110 then has a visual and behavioral unity achieved by adding to the list 13 of reproduction and behavioral characteristics associated with the first object 11 at least one reproduction and/or behavioral characteristic contained in a list 14 of such characteristics associated with the second multimedia object 12.

The list 150 of characteristics produced in this way by combining the lists 13 and 14 of characteristics is associated with the complex multimedia object 110 and saved in a content server, for example in the form of an XML format configuration file.

Moreover, it is possible, by means of the invention, to have a first complex multimedia object communicate with at least one second complex multimedia object by transmitting control messages or events from one to the other, for example to implement a scenario for chaining the behavior of a plurality of complex multimedia objects.

To do this, the code of a first complex multimedia object defines a set of events and preconditions to be met for those events to be triggered.

Those preconditions can correspond to actions in a complex multimedia object provoked by a user or any other event that could occur in the execution of certain actions by a complex multimedia object itself: e.g. expiry of a time counter (timer) internal to a complex multimedia object or triggering the playback of a video file contained in a first complex multimedia object after playing back a music file contained in a second complex multimedia object.

To summarize, as shown in FIG. 2, the method of the invention of creating at least one complex multimedia object to be reproduced in a multimedia environment advantageously includes a step 21 of dynamically encapsulating at least one second multimedia object 12 in a first multimedia object 11 to form a complex multimedia object 110 having behavioral characteristics in said multimedia environment defined in a list 23 of behavioral characteristics associated with it, said list being obtained by transferring into a list 13 of behavioral characteristics associated with the first multimedia object 11 a set of characteristics contained in a list 14 of behavioral characteristics associated with said second multimedia object 12.

This dynamic encapsulation step 21 is preceded by a step 20 of verifying that said second multimedia object 12 is a of a type that belongs to a set of multimedia object types associated with said first multimedia object 11 and for which encapsulation 21 within said first multimedia object 11 is authorized, which guarantees the visual and behavioral unity of the complex multimedia object 110 created in this way.

In a preferred implementation of the invention, to promote the intuitive and simple use aspect for amateur Internet environment creators, the dynamic encapsulation step 21 is triggered after dragging and dropping the second multimedia object 12 onto at least one predetermined area 15 of said first multimedia object 11.

Such a function proves perfectly consistent with the main object of the invention, which is to provide a method that is so simple for amateur users to implement and use that it encourages creativity in the use of on-line personalized and personal multimedia environments such as websites and blogs.

1. A method of creating at least one complex multimedia object for reproducing in a multimedia environment, said method comprising:
dynamically encapsulating at least one second multimedia object in a first multimedia object to form a complex multimedia object having behavioral characteristics in said multimedia environment defined in a list of behavioral characteristics associated with it obtained by transferring into a list of behavioral characteristics associated with said first multimedia object, a set of characteristics contained in a list of behavioral characteristics associated with said second multimedia object.

2. A method according to claim 1, wherein said encapsulation step is preceded by:
verifying that said second multimedia object is of a type that belongs to a set of multimedia object types associated with said first multimedia object and for which encapsulation in said first multimedia object is authorized.

3. A method according to claim 1, further comprising:
triggering said dynamic encapsulation step after dragging and dropping said second multimedia object onto at least one predetermined area of said first multimedia object.

4. A method according to claim 3, further comprising:
executing said verification step when said second multimedia object is dragged over said predetermined area of said first multimedia object.

5. A method according to claim 4, further comprising, during said verification step, delivering in said predetermined area at least one of visual and sound information representative of the result of said verification step.

6. A method according to claim 1, further comprising effecting said encapsulation step by manually transferring into a list of behavioral characteristics associated with said first multimedia object a set of characteristics contained in a list of behavioral characteristics associated with said second multimedia object.

7. A method according to claim 1, wherein said first multimedia object is contained in a first multimedia environment and said second multimedia object is contained in a remote second multimedia environment, said first and second multimedia environments being connected to each other with a communications network, said dynamic encapsulation step is a step of creating a communicating complex multimedia object to be reproduced in said first multimedia environment and adapted to exchange information with said second multimedia object via said communications network.

8. A method according to claim 1, wherein the method defines a relationship of at least one of belonging and of ownership between said complex multimedia object and at least one of at least one user and at least one multimedia environment in which said complex multimedia object is reproduced.

9. A method according to claim 1, wherein said multimedia environment is an interactive multimedia environment accessible on line via a communications network and at least one content server connected to said network, the method further comprising:
associating said uniquely identified complex multimedia object with at least one description and configuration file stored in at least one memory space reserved for said interactive multimedia environment in said content server and containing said list of behavioral characteristics associated with said complex multimedia object.

10. A multimedia object that is reproduced in a multimedia environment, wherein it is produced by a method according to claim 1 of creating a complex multimedia object.

11. A computer program product stored on an information medium readable by computer and executable by a microprocessor, said product comprising code instructions for executing in a multimedia environment a method according to claim 1 of creating a complex multimedia object.

12. An interactive multimedia environment accessible on line from a communications terminal connected to at least one interactive multimedia content server via a communications network, said environment comprising at least one consultation area for consulting a plurality of multimedia objects arranged to form a multimedia scene, said consultation area optionally being shared by a plurality of users, comprising at least one complex multimedia object according to claim 10.

13. A multimedia environment according to claim 12, said environment comprising at least one dedicated space for on-line creation of at least one complex multimedia object adapted to be reproduced in said consultation area, access to said dedicated creation space being restricted to certain predetermined users.
